(19) United States
(12) Patent Application Publication
(10) Pub. No.: US 2010/0026304 A1
(43) Pub. Date: Feb. 4, 2010

(54) Method and Apparatus for Analysing Geological Features

(76) Inventor: Andrew Duncan, Mundaring (AU)

Correspondence Address: Sunstein Kann Murphy & Timbers LLP, 125 SUMMER STREET, BOSTON, MA, 02110-1618, US

(21) Appl. No.: 12/525,218

(22) PCT Filed: Jan. 31, 2008
(86) PCT No.: PCT/AU08/00110

§ 371 Date: Jul. 30, 2009

(30) Foreign Application Priority Data
Jan. 31, 2007 (AU) 2007900454

(51) Int. Cl. G01V 3/08; G01V 7/00

(52) U.S. Cl. 324/345; 702/2

(57) ABSTRACT

An apparatus (10) for analysing geological features comprises a receiver (20) for measuring a magnetic field received from adjacent geological features (18) excited by a periodic transmitted electromagnetic signal, wherein the measured magnetic field is a scalar amplitude of the magnetic field or a scalar amplitude of the magnetic field is derivable from the measured magnetic field, wherein the receiver generates a received signal from the measured magnetic field; and
a processor (28) for filtering unwanted signal components which are substantially synchronous with the periodic transmitted electromagnetic signal from the scalar amplitude of the received signal or the scalar amplitude derived from the received signal, such that target geological features are able to be analysed using the filtered scalar amplitude.

### FIELD OF THE INVENTION

The present invention relates to electromagnetic geological survey and prospecting and in particular to measurement of a received magnetic signal for analysis of geological features.

### BACKGROUND

It is known to have air, land and sea systems for undertaking electromagnetic geological survey and prospecting for geological features, such as bodies of oil, gas, metal ores etc. However such systems suffer from limitations.

For example, conventional airborne traversing electromagnetic measurements are currently restricted to analyse time-varying signals with frequencies of approximately 25 Hz and higher. At lower frequencies, conventional axial magnetic field sensors taking measurements of magnetic field strength or related quantities become polluted by interference from the angular motion of the sensors in the geomagnetic field and by the low fidelity of the sensors themselves at these temporal frequencies. This low frequency limit has dropped in the last decades as a result of improvement of sensors, and improved suspension systems to shield them from rapid rotations during traversing. However further gains are difficult to achieve in this way. As a result surveying that has been done with traversing systems employing axial sensors analysing frequencies lower than approximately 25 Hz has resulted in data that can be demonstrated to be deleteriously affected by the traversing motion.

Stanley (U.S. Pat. No. 5,444,374) describes using a magnetic field detector in order to make electromagnetic measurements which can be separated into spatially varying magnetic field and a temporally varying magnetic field. Stanley sets a minimum frequency (S/2E) for acquisition of the time-varying part of the electromagnetic signal and relates it to the speed of traversing (S) and the distance above ground (E). These restrictions are put in place in Stanley to mitigate the interference at low frequencies from the spatially-varying geomagnetic signals of geological formations that the sensor moves past. Stanley does not consider or present a solution to the problem of the time varying magnetic field of non target geological features interfering with the time varying magnetic field of target geological features such as nearby geological features interfering with the magnetic field of deeply-buried targets.

### SUMMARY OF THE PRESENT INVENTION

According to one aspect of the invention there is an apparatus for analysing geological features comprising:
a receiver for measuring a magnetic field received from adjacent geological features excited by a periodic transmitted electromagnetic signal, wherein the measured magnetic field is a scalar amplitude of the magnetic field or a scalar amplitude of the magnetic field is derivable from the measured magnetic field, wherein the receiver generates a received signal from the measured magnetic field; and
a processor for filtering unwanted signal components which are substantially synchronous with the periodic transmitted electromagnetic signal from the scalar amplitude of the received signal or the scalar amplitude derived from the received signal, such that target geological features are able to be analysed using the filtered scalar amplitude.

The scalar amplitude is either a direct measurement of the total magnetic field or is derived from other measurements.

In an embodiment the receiver is mobile such that in use it traverses an area containing the geological features. The receiver is arranged to continually measure the magnetic field while traversing the area.

In an embodiment the receiver comprises a total field sensor. In another embodiment the receiver comprises a tri-axial sensor that produces an output from which the scalar amplitude of the magnetic field is derived.

In an embodiment the processor derives the scalar amplitude of the magnetic field from the output of the tri-axial sensor.

In an embodiment the processor filters out specified frequencies from the received time-varying signal in order to retain frequencies that are relevant to target geological features.

In one embodiment the time-varying transmitted signal includes low frequencies, in the vicinity of 1 Hz.

In one embodiment the time-varying receiver signal includes low frequencies, in the vicinity of 1 Hz.

In an embodiment the filtering targets geological features of a specified range of depths.

In an embodiment the processor filters out unwanted asynchronous interference relative to the periodic transmitted electromagnetic signal from the received signal. In an embodiment filtering of unwanted asynchronous interference removes frequency components of the received signal which are substantially not at a frequency of the transmitted signal.

In an embodiment the filtering of unwanted synchronous interference is conducted by stacking periodically repeating parts of the received signal. In an embodiment the parts stacked is related to traversal of the sensor over a distance related to a spatial wavelength expected in a received signal from target geological features. Typically the signal part is a half period of the signal.

In an embodiment the apparatus further comprises a transmitter for transmitting the transmitted electromagnetic signal. The transmitter is positioned adjacent the geological features.

In an embodiment the transmitter is stationary. In an embodiment the transmitter is fixed to either a ground surface or an underground surface or an underwater surface.

In another embodiment the transmitter is mobile. In one embodiment the transmitter moves with the receiver. In an embodiment the transmitter is mounted to a vehicle, aircraft or watercraft.

In an embodiment the receiver traverses adjacent to the geological formation along a ground surface, an underground surface, or in a borehole, or on water, or under water.

In an embodiment the processor further processes the filtered signal for analysing geological features in the area. Alternatively a second processor further processes the filtered signal for analysing geological features in the area.

In an embodiment the processor is spaced apart from the receiver. In an embodiment the received signal is recorded for later processing by the processor.

The apparatus further comprises a means for synchronising a waveform of the transmitted signal with a waveform of the received signal.

In an embodiment the receiver comprises two or more magnetic field sensors operating simultaneously and moving with a substantially fixed separation.

In an embodiment the two or more sensors are used so as to calculate a spatial gradient of the scalar magnetic field.

In an embodiment the apparatus further comprises an additional stationary magnetic field sensor which produces a reference signal used to removal time-varying external interference which is substantially simultaneously common to the receiver.

In an embodiment the transmitter transmits a bipolar periodic square current waveform.

In an embodiment the waveform has approximately a 50% mark/space ratio. In an embodiment the waveform has approximately a 100% mark/space ratio. In an embodiment the transmitter transmits a sinusoidal waveform of a given frequency.

In an embodiment the transmitter transmits a superposition of these waveforms.

In an embodiment the transmitter transmits a time-sliced version of these waveforms.

In an embodiment the transmitted signal is recorded with respect to time for use in processing of the received signal.

In an embodiment the processor outputs results in the time domain or the frequency domain.

In an embodiment the position of the transmitter is recorded with respect to time. In an embodiment the position of the receiver is recorded with respect to time.

In an embodiment the transmitter comprises a loop or dipole antenna.

According to another aspect of the present invention there is a method of analysing geological features comprising:
measuring a scalar amplitude of a magnetic field received from adjacent geological features excited by a periodic transmitted electromagnetic signal and generating a received signal therefrom; and
filtering unwanted signal components which are substantially synchronous with the periodic transmitted electromagnetic signal from the received signal, such that target geological features are able to be analysed.

According to a further aspect of the present invention there is a computer program comprising instructions for causing a computer processor to:
receive data representing a scalar amplitude of a magnetic field received from adjacent geological features excited by a periodic transmitted electromagnetic signal; and
filter unwanted signal components which are substantially synchronous with the periodic transmitted electromagnetic signal from the received data, such that target geological features are able to be analysed.

According to yet another aspect of the present invention there is a computer readable storage medium comprising the computer program in a computer useable form.

### SUMMARY OF FIGURES

In order to provide a better understanding of the present invention preferred embodiments will now be described in greater detail, with reference to the accompanying drawings, in which:

FIG. 1 is a schematic diagram of the apparatus for analysing geological features;

FIG. 2 is a three-dimensional schematic graph of a total magnetic field vector which includes components from a tri-axial magnetic field sensor;

FIG. 3 is in a schematic representation of the apparatus of FIG. 1 in which a transmitter of the apparatus is fixed and a receiver of the apparatus is airborne;

FIG. 4 is a schematic representation of the apparatus of FIG. 1 in which the transmitter is fixed and the receiver is ground-based;

FIG. 5 is a schematic representation of the apparatus of FIG. 1 in which the transmitter is airborne and the receiver is also airborne;

FIG. 6 is a schematic representation of the apparatus of FIG. 1 in which the transmitter is stationary and the receiver is traversing through water;

FIG. 7a is a schematic block diagram of the apparatus of FIG. 1 in which the receiver uses a tri-axial sensor;

FIG. 7b is a schematic block diagram of the apparatus of FIG. 1 in which the receiver uses a total field sensor;

FIG. 8 is a schematic diagram of the apparatus of FIG. 1 in which the receiver comprises a) two rigidly connected sensors, b) two simultaneously operating sensors, and c) a stationary sensor; and

FIG. 9 is a schematic illustration of 4 different transmitter waveform types.

### DETAILED DESCRIPTION OF EMBODIMENTS OF THE PRESENT INVENTION

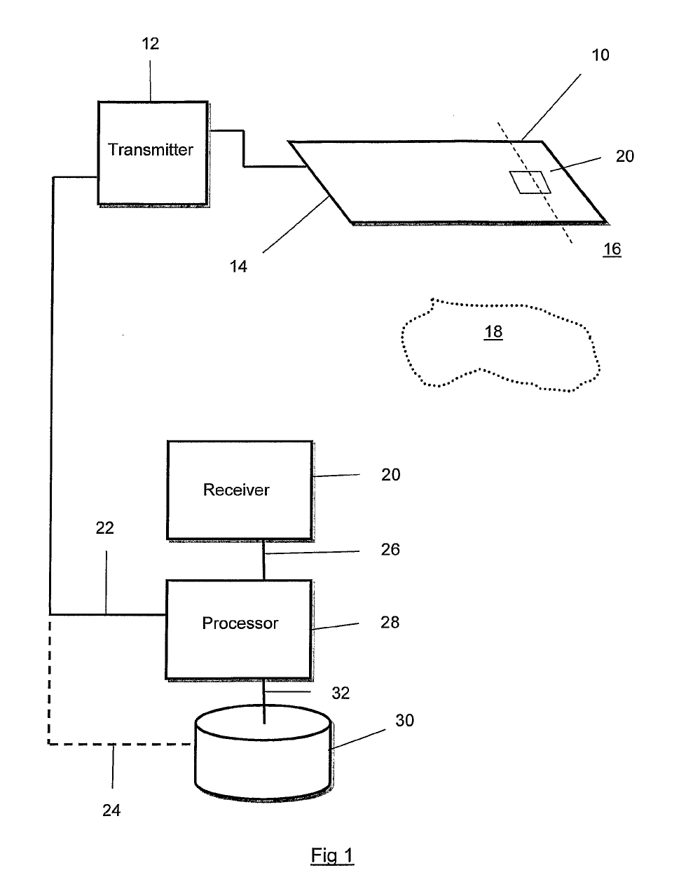

Referring to FIG. 1, there is shown an apparatus 10 for analysing geological formations 18 below the surface of the ground 16. The apparatus 10 includes a transmitter 12 having an antenna 14, a receiver 20 and a processor 28. The transmitter 12 transmits a periodic electromagnetic signal from the antenna 14 which will be described further below. The signal has the effect of exciting the target geological body below the ground 16 in the vicinity of the antenna 14 according to its properties including its electrical conductivity. As is known to those skilled in the field of this invention the electromagnetic signal will excite the geological body causing electrical currents to flow therein. This inturn will produce a magnetic field which adds to the Earth's magnetic field and also with other sources of magnetic fields. By moving a magnetic field receiver 20 in relation to the ground 16 (and thus the geological body 18) localised measurements of the magnetic field can be taken by the receiver traversing an area of interest, which inturn can be used to determine characteristics of the geological formation 18 such as its electrical conductivity, its location and it dimensions.

The receiver 20 produces electrical signals 26 representing the magnetic field measurements for processing by the processor 28. The processor 28 can be either a specialised purpose build processor or a generic PC. The processor 28 is arranged, typically by operating a computer program, to filter the electrical signal as will be described further below. The processor 28 will store the filtered signal 32 in a storage device 30, such as a hard disk drive. The disk drive may be local or remote. The filtered signal 32 may be further processed, either by the same processor 28 or by another local or remote processor to interpret the filtered signal and provide an output to a user. The computer program will typically be loaded onto memory, such as RAM, of the PC from a storage medium, such as a floppy disk, Compact Disk, DVD or flash memory.

The signal transmitted by the transmitter 12 may be stored in the storage 30. Timing information related to the transmitted signal may be provided to the processor 28 by link 22 for synchronisation purposes. Alternatively the timing information may be stored in storage 30 via link 24. Synchronisation may be determined in other ways as described below.

The transmitter 12 may be stationary or traversing, in the vicinity of the geological formations 18 being investigated. The transmitter 12 provides a source of energy for the measurement. It consists of a transmitter instrument, coupled to the transmitter antenna 14 which could be a loop of wire or a wire attached (grounded) at 2 points to ground or water (grounded dipole). The transmitter may be on the ground, airborne or waterborne.

During transmission the antenna 14 carries a time-varying electric current. The transmission causes electric current to flow in the ground or other electrically-conducting medium, such as water, adjacent to the antenna. When the transmitter antenna is grounded, electric current is injected directly (galvanically) into the geological formations in the vicinity. When the transmitter antenna 14 is a loop, electric current is induced, via electromagnetic induction, into the adjacent electrically-conducting media, including geological formations 18.

The transmitter antenna 14 can be of a range of dimensions. For a fixed loop or grounded dipole, the dimension of the antenna 14 is likely to be somewhere in the range 100 metres to several kilometres. An airborne transmitter loop is likely to be of dimension of the order of 10-25 metres. The dimension of the antenna 14, and the magnitude of the electric current flowing within it, affects the detection distance of the apparatus.

There are a range of possible time-varying transmitter signal waveforms that could be transmitted through the transmitter antenna 14. One option could be described as a periodic alternating polarity square waveform with approximately 50% duty cycle or mark/space ratio. The waveform would be described by its fundamental frequency, the frequency at which full periods are repeated. Another option for the transmitter signal can be described as a periodic alternating polarity square waveform with approximately 100% duty cycle or mark/space ratio. The waveform would be described by its fundamental frequency, the frequency at which full periods are repeated. Another option for the transmitter signal waveform is a sinusoid of a given frequency. Other signal waveforms are also possible. The transmitter signal waveform could be a superposition or a time-sliced combination of the waveforms above, including a waveform in which two or more waveforms of different frequencies are superposed or time-sliced.

FIG. 9 shows a series of possible transmitted waveforms in which: a) is a bipolar square wave with a 50% duty cycle; b) is a bipolar square wave with a 100% duty cycle; c) shows a sinusoidal waveform; and d) shows a time sliced waveform with elements of two frequencies of 50% duty cycle square waves.

While the receiver 20 can take magnetic field measurements while stationary, significant benefits arise when the receiver 20 traverses adjacent to the geological formations 18 being evaluated. In this context adjacent means near enough to receive a detectable return signal. The receiver 20 includes one or more magnetic field sensors and a system for measuring the signals output from the sensors.

The sensors measure a scalar amplitude of the magnetic field, at the location of the magnetic field sensors in the area at a given moment in time.

The sensors can be of a type that directly measures the time-varying “total” field (the time-varying scalar amplitude of the vector magnetic field at the sensor location). Examples of this type of sensor include optically-pumped alkali vapour magnetometers and proton precession magnetometers, such as an optically-pumped Caesium vapour sensor, which emits an approximately sinusoidal signal of a frequency (the larmor precession frequency) which is proportional to the magnetic field amplitude at the sensor.

The sensors may alternatively be of a tri-axial type wherein the “total” field is measured according to its axial components. A scalar value for the total field can be calculated from the three component magnetic field measurements using precise knowledge of the relative orientation and sensitivity of the three axial sensors. Individually, these sensors measure the time-varying magnetic field along their respective axis. Three approximately orthogonal sensors together are referred to as a tri-axial sensor. The tri-axial sensors may be any type of axial sensor that is capable of measuring a time-varying magnetic field or related quantity. Some examples of sensors satisfying this criterion are: coils, feedback coils, fluxgate magnetometers and SQUID magnetometers.

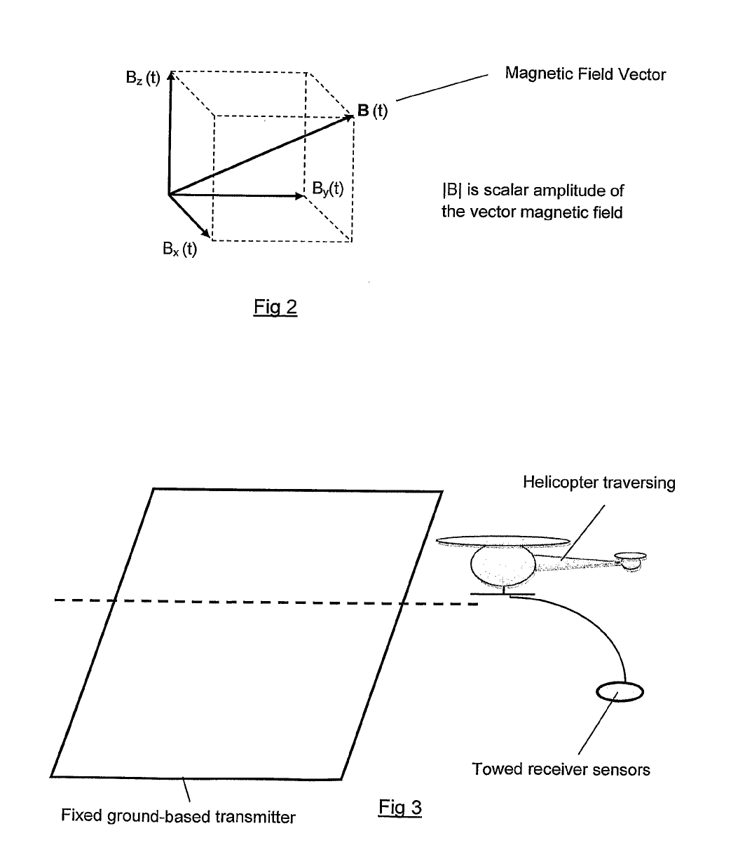

In the case of a tri-axial type the total magnetic field is derived from measurements of signals on each of the approximately orthogonal axes. FIG. 2 illustrates the measurement of the vector of magnetic field B(t), which includes approximately orthogonal axial components Bx(t), By(t) and Bz(t). The scalar magnetic field |B(t)| is derived from B(t). The X, Y and Z axes are approximately orthogonal however accurate calculation of |B(t)| from Bx(t), By(t) and Bz(t) requires information gained from accurate calibration of the geometry and sensitivity of the three axial sensors.

The total field, either measured directly or derived from a tri-axial magnetic field sensor, is a useful quantity to measure in that it is independent of the orientation of the sensor. In a receiver 20 adapted to traverse during data collection this is an important issue. The receiver 20 can collect data over a large area because it is traversing, yet the fidelity of the data can remain high. Magnetic field sensors are sensitive to angular motion if they measure only a component of the magnetic field. This is because the signals that are desired to be measured are much smaller than the background magnetic field of the earth (geomagnetic field). Any small rotational motion of the sensors can result in the large geomagnetic field causing a large variation in output of the sensor as the sensor rotates in time with respect to the geomagnetic field. Rotational motion effects will be worse at low frequencies because the amplitude of the rotations experienced by the sensor in motion are larger at lower frequencies. Unfortunately, it is lower frequencies that are of interest in electrical geophysical surveys in many scenarios. However this problem is substantially mitigated in the present invention.

For a tri-axial sensor to be used in a survey where the aim is to calculate a total field as above, the three sensors will be rigidly fixed to each other and will be suspended in the receiver 20 in a manner to shield them from mechanical shocks due to the traversing of the receiver 20 along the ground, in the air or in water.

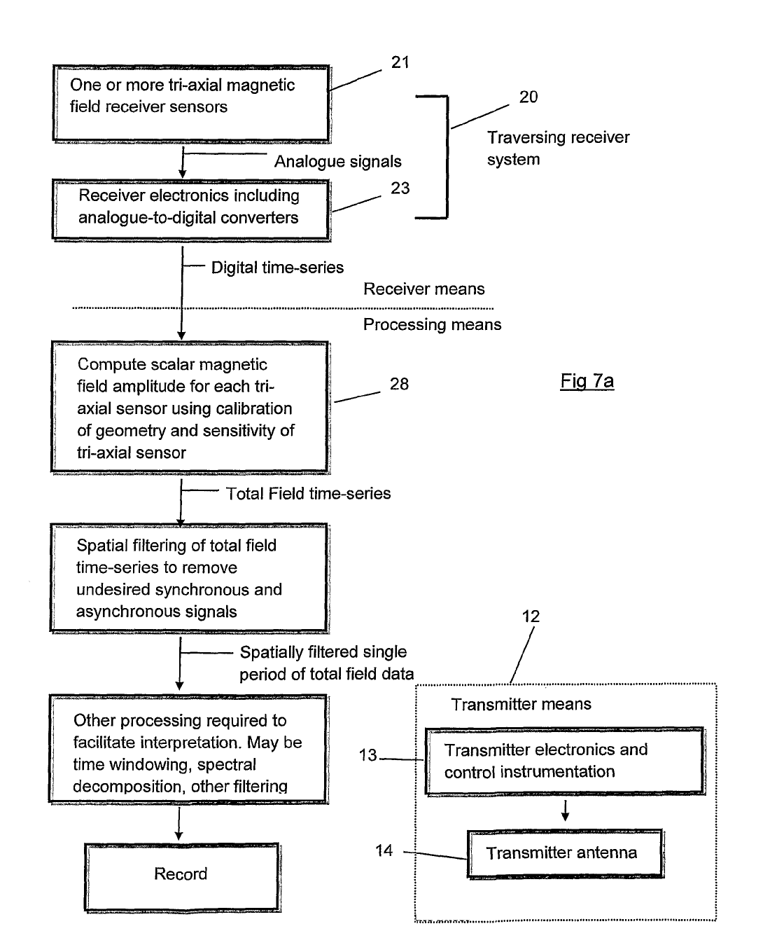

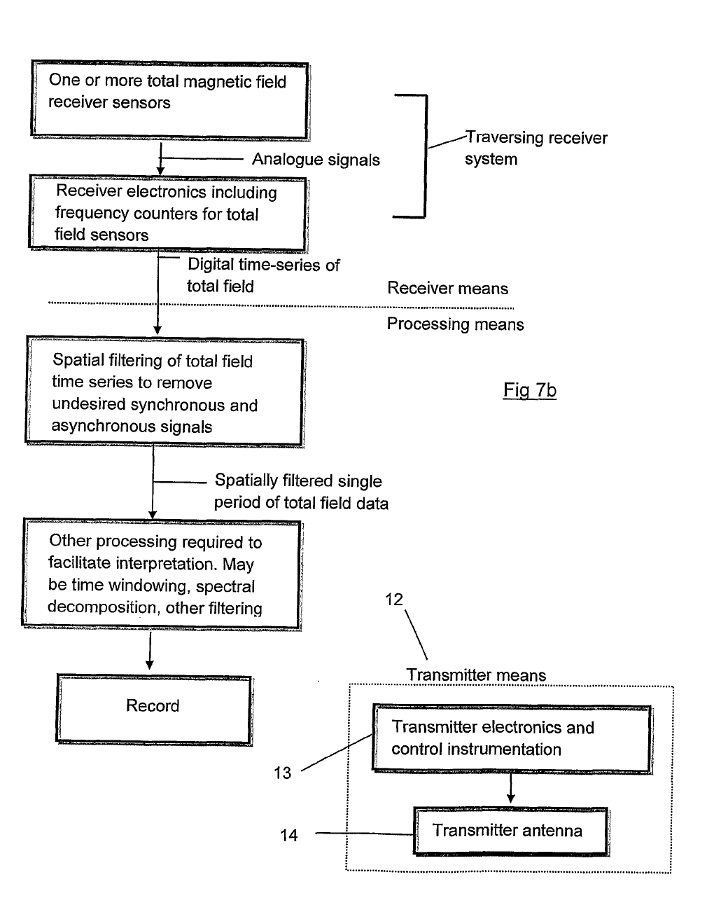

As shown in FIG. 7a the tri-axial sensors 21 typically produce one or more analogue signals. The signals are provided to receiver electronics 23 which include analogue to digital converters (ADC). The ADC output a time series data for use by the processor 28.

The transmitted signal and the received signal are synchronised. That is, when processing the received data, it is known at which point in the transmitter period each sample from the receiver has been measured. This synchronisation can occur in several ways, such as by synchronised clocks or counters or timing mechanisms in both transmitter 12 and receiver 20, by transfer of timing information from the transmitter 12 via links 22 and/or 24, or by a calculation by the processor 28 based on the received data to predict the phasing of the transmitter 12.

Those skilled in the field of this invention will know that a low frequency measurement, often lower than, or in the vicinity of, 1 Hz, is required in an EM, MMR or MIP survey to detect deeply buried targets in environments with significant electrically-conductive material overlying them. Additionally, a low frequency measurement is required in an EM survey to discriminate a geological target that is a good electrical conductor from a geological target that is an excellent electrical conductor.

The processor 28 includes hardware and software which applies processing methodologies to the signals measured by the receiver 20 in order to generate the required data of the desired quality and form. The processor 20 would normally be located adjacent to the receiver 20 but, in some cases, some or all of the processor 28 may be remote from the receiver 20 and processing may occur some time after the data is collected. The processor 28 may comprise one or more CPUs.

The magnetic field signal resulting from the current flowing in the target can be quite small when compared with undesired signals from sources of interference. The processor 28 enhances the desired signal at the expense of undesired signals from sources of interference. Interference may arise from the sensor itself, power transmission lines, magnetic geological features, atmospheric electrical discharges, natural background magnetic field variations and geological formations other than the targeted formations. These sources are capable of causing interference over a range of temporal frequencies which overlap with the temporal frequencies of interest in carrying out a traversing electromagnetic survey.

The nature of the interference varies with the source of the interference. In general, the interference can be classified as synchronous and asynchronous. Synchronous interference, perhaps more correctly termed unwanted synchronous signal components, could be defined as signals measured by the receiver 20, resulting from the transmission, which are not from the target of interest. A good example of this is signals arising from currents induced in geological formations that are not of interest. These may be geological formations which are near the receiver 20 and not deep enough to be in the region of interest or perhaps from a discrete conductor which is not large enough or conductive enough to be of interest.

Asynchronous interference could be defined as signals which bear no resemblance to the periodicity and repetition of the transmitted signal. Examples are interference from power transmission lines, atmospheric discharges (lightning), the geomagnetic response of geological formations being traversed past and natural background magnetic field variations. Power transmission lines broadcast magnetic fields mainly at the local power transmission frequency, typically 50 or 60 Hz, and harmonics thereof. Atmospheric discharges can result in a fairly broad spectrum of interference. It can be seen that traversing in the vicinity of geological formations with some magnetism can cause interference to measurements. The temporal spectrum of this interference is related to the speed of traverse and the distance to the source of the magnetism. The resulting interference has most of its power at very low temporal frequencies. Likewise, the spectrum of interference from natural background variations in magnetic fields is mainly concentrated at low frequencies. All of these sources of interference result in signals which are asynchronous with the transmitted signals and thus asynchronous with the desired received signals.

The processor 28 is arranged to spatially filter time-varying signals in order to remove asynchronous interference and unwanted synchronous signals. This allows the desired low frequency data to be used to identify targets which are detected at those frequencies.

The processor 28 employs filtering techniques that are capable of recognising periodic or repetitive signals. Often the target of the prospecting technique is some distance from the traversing receiver 20. Its size and distance from the receiver 20 may result in a geophysical response which repeats over quite a large spatial dimension. As the receiver 20 traverses across the region where the target's response is apparent, many periods of the periodic transmitted signal will have been issued. One of the functions of the processor 28 is to produce a version of the periodic received signal which is spatially filtered from the many periods of the received waveform. This spatial filtering may be achieved by simple averaging, but is more likely to be achieved by a more sophisticated process which might include a tailored spatial filter, wavelet filtering or correlation techniques.

In the case that the type of sensors being used in the receiver 20 are tri-axial sensors then the processor 28 will calculate the time-varying total field. This process relies on a calibration of the relevant orientation of each of the three axial sensors and the sensitivity of each axis. Tri-axial sensors may be chosen because they may offer superior performance over some of the frequency band of interest, compared with a total magnetic field sensor.

The simplest method to remove asynchronous signals is to average (“stack”) the repetitive received signals in order to attenuate or remove elements of the signals which are not repeating. In practice, the stacking process can combine various filtering techniques which improve the process of extracting the repetitive signal from the interference.

The aim of the processing is to produce high fidelity electromagnetic field data which includes data at low temporal frequencies. The output from the spatial filtering will typically be a single period, or half-period, of total field time-series. Depending on the spatial bandwidth of the spatial filtering, the output rate of the period of data can be chosen. For example, if the spatial filtering of the periodically repeating time-series restricts the output to spatial frequencies of less than approximately one cycle per 100 metres then the product of the spatial filtering could be generated at an interval of say every 50 metres or less to avoid spatial aliasing of the output.

The apparatus can be configured such that the measured survey data are used in the processor 28 to predict the expected primary total field at the receiver 20 sensors, that is, the total field caused at the traversing sensors by current flowing in the transmitter 12.

Alternatively the apparatus can be configured such that the measured locations of the traversing sensors in the apparatus and the measured locations of the fixed or moving transmitter and the measured or predicted current flowing in the transmitter 12 are used, in the processor, to calculate the expected primary total field at the receiver sensors. That is, the total field caused at the traversing sensors by current flowing in the transmitter 12.

An example of this process is the use of the simple idea that, at low temporal frequency, the secondary field (the response from electrical currents flowing in geological conductors) asymptotes linearly to zero at DC, assuming equal current transmitted at the harmonics of the transmitter frequency. In some types of measurements it is desired to subtract the primary field from the measured field in order to calculate a measurement relating to geological targets at a time at which electrical current is flowing in the transmitter 12 (an on-time measurement).

In frequency domain nomenclature, this style of measurement relates to an in-phase measurement. Those skilled in the field of the invention would understand that an on-time or in-phase measurement, especially at low temporal frequency, can yield important information about highly conductive geological targets.

The apparatus can be configured such that the electrical current flowing in the loop or wire transmitter 12 is measured by a device capable of recording such electrical current as a function of time or frequency. Those skilled in the field of the invention would recognise that the fields measured and/or calculated by the receiver and/or processor 28 depend on the variation with time of the current waveforms flowing in the transmitter. Thus, it is useful to measure the true current flowing in the transmitter 12 in order to accurately process and interpret the corresponding received signals and products derived from them. This measurement of the electrical current flowing in the transmitter 12 allows for some flexibility in the exact nature of the shape of the transmitter current variation in time, but in general the variation will be periodic.

The apparatus can be configured such that the time-varying total field measured by the receiver 20 and processed by the processor 28, or products derived from them, are presented in the time or frequency domain. In time domain presentations, fields would typically be presented as a result relating to the field at a series of time windows. In frequency domain, fields would be presented as an amplitude, phase, in-phase amplitude or quadrature amplitude relating to the field at a given temporal frequency. Those skilled in the field of the invention would recognise that time-domain and frequency-domain data results may be derived from each other and do not depend on the exact nature of the transmitter 12.

The apparatus can be configured such that the processor 28 treats the data as a two-dimensional grid of data. Those skilled in the field of the invention would be aware that traversing geophysical field data would normally be collected in an organised pattern of lines covering a survey area. Conventionally, the data covering the surveyed area could be displayed and processed as a two-dimensional image instead of as a series of one-dimensional profiles. The processing techniques discussed above could be applied to data in this two-dimensional form.

The apparatus can be configured such that the total field measured by the receiver 20 and processed by the processor 28, or products derived from them, are presented in profiles, plans, images, cross-sections, decays and/or spectra.

The apparatus can be configured such that the total fields are interpreted using software specifically-formulated for simulating such data. Those skilled in the field of the invention would understand that data acquired in the field from the apparatus can be simulated using a chosen geological model type. The response of the chosen geological model is compared with the measured or computed field data. The model can be updated to enhance the coincidence of the measured field data with the computed model response. Examples of the type of models used for the simulation may be of half-space, thin-sheet, two-dimensional, three-dimensional or layered earth types.

An embodiment of the invention is shown in FIG. 7a. In this embodiment, the transmitter comprises transmitter electronics and control instrumentation 13 which generated the time-varying signal and the transmitter antenna 14. The receiver 20 comprises one or more triaxial magnetic field sensors 21, and receiver electronics including the DAC 23. The processor 28 is arranged to operate under the instructions of the computer program. It receives the digital time-series data and computes a scalar magnetic field amplitude for each of the tri-axial sensors using information on the calibration of geometry and sensitivity of the tri-axial sensor. The scalar magnetic field amplitude is represented as a total field time series data. This data undergoes spatial filtering to remove undesired synchronous and asynchronous signals. The spatially filtered signal for a single period of total field data is then recorded in the storage 30 for other processing required to facilitate interpretation of the geological features measured.

An alternative embodiment of the invention is shown in FIG. 7b. In this embodiment the one or more total magnetic field receiver sensors are used which produce an analogue signal. This is provided to the receiver electronics to produce the digital time-series data. In this case the processor does not need to compute the scalar in the field amplitude as the digital time series data is already a total field measurement. The remainder of the process is the same as in FIG. 7a.

The result of the spatial filtering is a valuable data set of high fidelity, which includes low temporal frequency data collected from a moving platform covering a lot of ground in a relatively short period of time. Low temporal frequencies are important in the identification and discrimination of targets in conductive terrain. As a result the present invention will have the capability to detect targets more deeply-buried than other known traversing electromagnetic geophysical analysis systems.

Various techniques can then be used to infer characteristics of the geological formation 18. Broadly-speaking, the techniques outlined here are versions of the electromagnetic (EM), magnetometric resistivity (MMR) and magnetic induced polarization (MIP) geophysical techniques. Because the techniques employ a total field measurement or calculation, they might more accurately be described as “total field EM”, “total field MMR” and “total field MIP” or TFEM, TFMMR and TFMIP respectively.

In particular the measured magnetic fields are used to interpret the path of current flow in the geological formations 18 and thus infer, generally using mathematical simulations, the spatial distribution of electrical conductivity and other electrical properties, such as polarization, in the formations 18.

The technique outlined in this invention could be carried out in a survey traversing along the ground surface, traversing in an aircraft, traversing underground in a mine environment, traversing in a borehole or traversing on or under water.

FIG. 3 shows a mobile airborne receiver 20 carried by helicopter which passes over a fixed ground-based transmitter loop antenna 14, which defines an area in which the geological formations of interest are located. The helicopter tows the receiver 20 (or sensor of the receiver 20) along a line across the area.

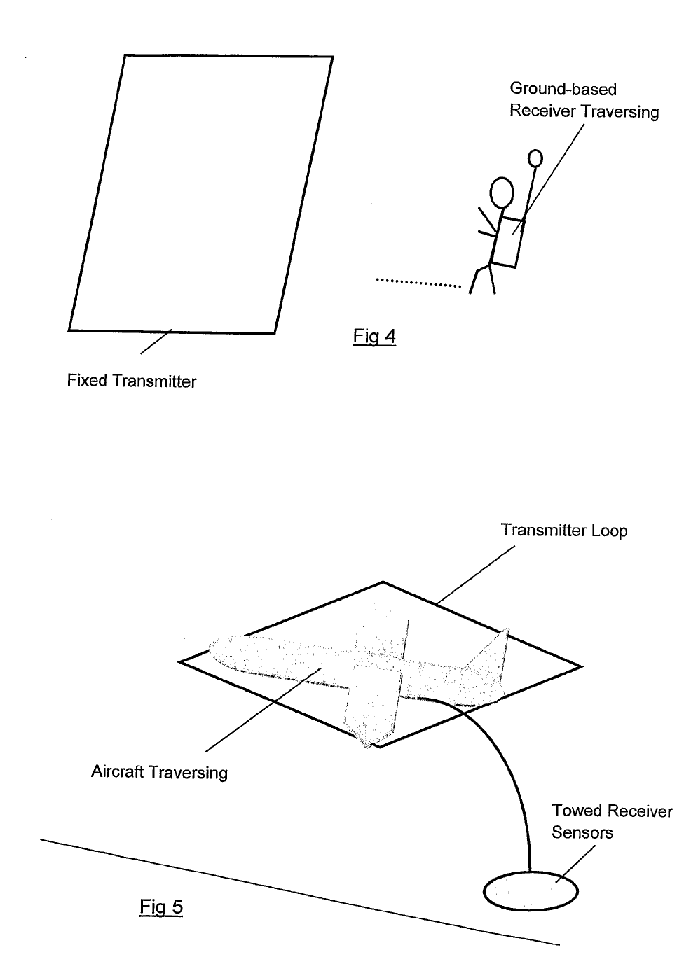

FIG. 4 shows a fixed loop transmitter antenna 14 and a ground based mobile receiver 20 which travels across the area defined by the antenna loop 14.

FIG. 5 shows an aircraft having a transmitter loop antenna 14 which tows a sensor of the receiver 20 behind it.

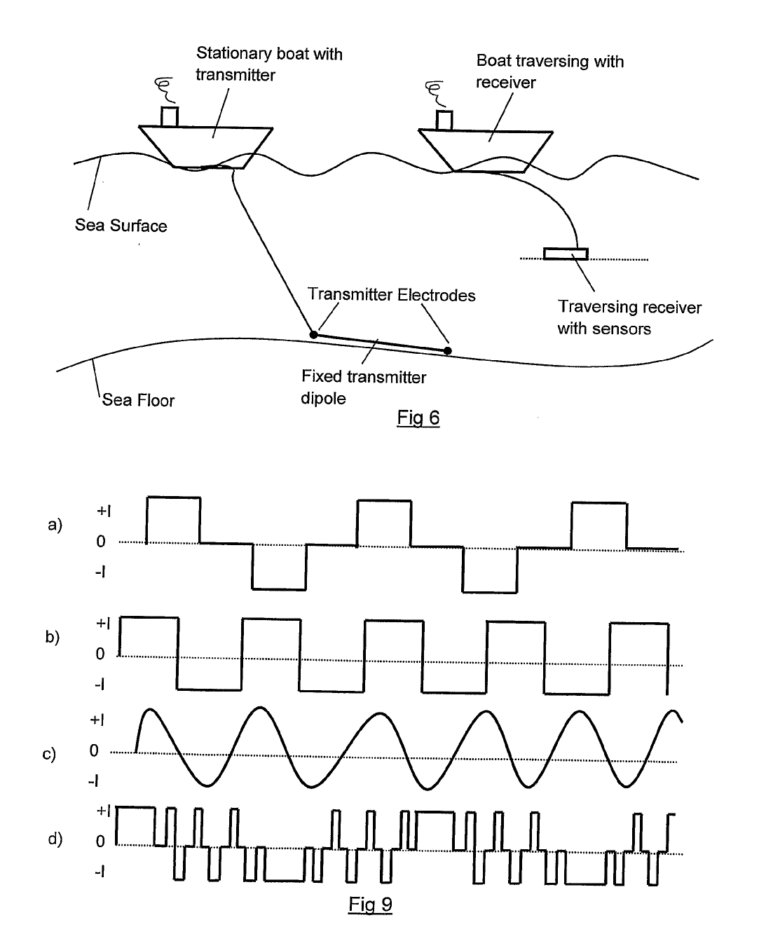

FIG. 6 is a schematic representation of a seaborne survey vessel floating on the sea surface in which the transmitted signal is generated. The signal is provided to a fixed transmitter dipole antenna on the sea floor. Also shown is a seaborne vessel travelling across the sea surface towing a receiver 20, which traverses an area above the sea floor as the vessel moves across the water.

The apparatus can be configured such that the transmitter 12 is fixed on the ground surface or an underground surface or fixed underwater, with a loop antenna in order to carry out an electromagnetic (EM) survey or with a grounded wire antenna in order to carry out an MMR or MIP survey. Examples employing loops are shown in FIGS. 3 and 4. Grounded wire transmitter antennas are typically of a length (electrode spacing) in the order of several times the desired depth of detection or larger. It is desirable to know reasonably accurately the path of the transmitter wire and/or the location of the grounded electrodes, this can facilitate the subsequent processing of the resulting data. The location of the antenna element of the transmitter 12 will be measured typically by a GPS system or other accurate mobile positioning system. Those skilled in the field of the invention would recognise that large transmitter 12 dimensions facilitate the detection and mapping of deeper geological targets.

The apparatus can be configured such that the transmitter 12 is airborne and traversing attached to an aircraft, such as a helicopter, fixed-wing aircraft or unmanned airborne vehicle. An example is given in FIG. 5. Normally in this variant of the system, the transmitter antenna 14 would be a loop (because other transmitter types are difficult to implement) attached to an aircraft to which was also attached the traversing receiver 20. The location of the elements of the airborne apparatus would be measured typically by a GPS system or other accurate mobile positioning system. Those skilled in the field of the invention would recognise that, whilst making geological measurements, a transmitter antenna would be as close to the ground as is safely possible, likely to be within 150 m or less of the ground surface if carried on a fixed wing aircraft. Mounted on a slow-moving helicopter, the antenna could be as low as 20-30 m above the ground. The present invention allows frequency measurements in the vicinity of 1 Hz. This will allow much deeper exploration in conductive terrain using a variant on the standard airborne EM technique.

The apparatus can be configured such that the receiver 20 is airborne, being carried by an aircraft, either helicopter, fixed-wing aircraft or unmanned airborne vehicle. An example is given in FIG. 3. The location of the sensor(s) in the receiver 20 will be measured or calculated, typically by use of GPS, but possibly by other means such as RF triangulation. A typical altitude for an airborne receiver 20 might be approximately 30 metres.

The apparatus can be configured such that the receiver 20 is moving along near the ground, being carried by a person or supported by a vehicle moving along the ground. An example is given in FIG. 4. The location of the sensor(s) in the receiver 20 will be measured or calculated, typically by use of GPS, but possibly by other means such as RF triangulation. An example of a ground traversing method of transporting the receiver 20 is given in the Stanley patent. Normally in this variant of the system, the transmitter 12 would be fixed in place on the ground surface.

The apparatus can be configured such that the transmitter 12 is waterborne and traversing attached to a boat. Normally in this variant of the system, the transmitter antenna 14 would be an electric dipole (because other transmitter types are difficult to implement) towed by a boat. The antenna 14 may be towed at the surface of the water or at a given depth. Most likely the antenna 14 will be towed at a depth approaching the water depth, in order to position the antenna 14 as close as possible to the floor of the water body, which would typically be an ocean adjacent to a continental mass. An example is given in FIG. 6.

The apparatus can be configured such that the receiver 20 is waterborne and traversing, towed by a boat. An example is given in FIG. 6. The receiver sensors may be towed at the surface of the water or at a given depth. Most likely the sensors will be towed at a depth approaching the water depth, in order to position the sensors as close as possible to the floor of the water body, which would typically be an ocean adjacent to a continental mass. This type of survey would be useful for sub-sea petroleum (oil and gas) exploration.

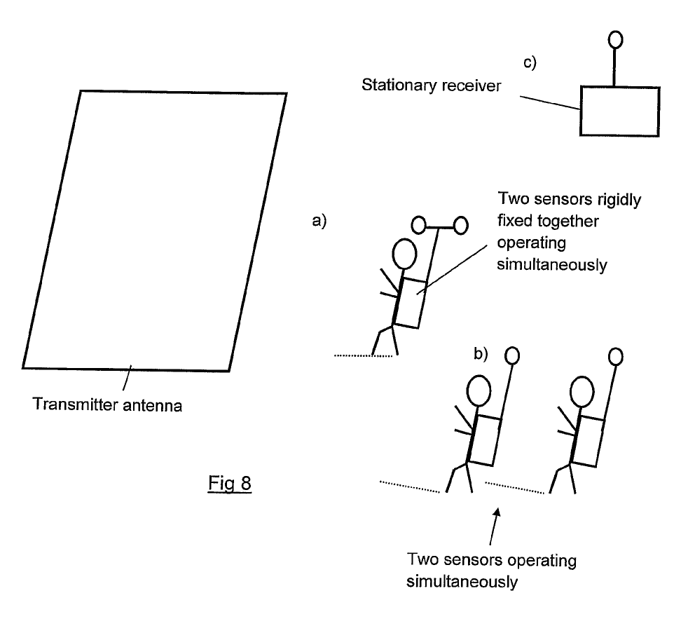

The apparatus can be configured such that the receiver 20 consists of two or more similar sensors, such as those described above, operating simultaneously and generally moving at a fixed separation, so as to measure or calculate a spatial gradient of the desired time-varying total field quantities by subtracting the quantity measured or calculated at one sensor from another. Those skilled in the field of the invention would understand that this style of measurement allows the removal of interference or unwanted signals that are simultaneously common to each sensor and thus may result in data of improved quality. One source of this interference that may be common to two or more sensors fixed rigidly to each other is interference resulting from motion discussed above. Another source is low temporal frequency natural background magnetic field variations. An example of the use of multiple sensors is given in FIGS. 8a and 8b.

FIG. 8 is a schematic representation showing in a) the use of sensors rigidly connected to calculate spatial gradient of the magnetic field, b) the use of two sensors traversing at approximately fixed separation and c) the use of a stationary sensor acting as a reference sensor while other sensors are traversing.

The apparatus can be configured such that the traversing receiver 20 is operated simultaneously with a stationary reference receiver in order to remove unwanted, common, time-varying fields from the data collected at the traversing receiver by subtracting the quantities measured or calculated from the reference station from those measured or calculated from the traversing receiver 20. Those skilled in the field of the invention would understand that this calculation may result in data of improved quality by virtue of the removal of interference such as low temporal frequency natural background magnetic field variations which are fairly spatially coherent. This type of interference is likely to be more of an issue with the low frequency operation capable of being undertaken with this apparatus than it would be with traversing systems operating at higher temporal frequencies without the benefit of a total field measurement. Normally, the reference receiver would be placed some distance from the survey area so that external fields can be measured in the absence of large fields from the transmitter antenna. An example is given in FIG. 8c.

The apparatus can be configured such that the processor 28 filters data by correlation methods or by pattern recognition methods or by filter methods such as wavelet methods to enhance desired features and attenuate or remove features that are not desired. Those skilled in the field of the invention would recognize that the transmitted and, thus, the desired received signals are conventionally periodic in nature and are well-correlated from one period to the next. A series of repeated periods of the received signal can be processed in the processor 28 to result in a best estimate of desired signal by correlation, pattern recognition or filtering methods so that undesired features are attenuated.

Modifications and variations may be made to the present invention without departing from the spirit of the present invention. Such modifications and variations as would be apparent to a person skilled in the field of the invention are intended to fall within the scope of the present invention.

1. An apparatus for analysing geological features comprising:
a receiver for measuring a magnetic field received from adjacent geological features excited by a periodic transmitted electromagnetic signal, wherein the measured magnetic field is a scalar amplitude of the magnetic field or a scalar amplitude of the magnetic field is derivable from the measured magnetic field, wherein the receiver generates a received signal from the measured magnetic field; and
a processor for filtering unwanted signal components which are substantially synchronous with the periodic transmitted electromagnetic signal from the scalar amplitude of the received signal or the scalar amplitude derived from the received signal, such that target geological features are able to be analysed using the filtered scalar amplitude.

2. An apparatus as claimed in claim 1, wherein the receiver is mobile such that in use it traverses an area containing the geological features.

3. An apparatus as claimed in claim 1, wherein the receiver comprises a total field sensor.

4. An apparatus as claimed in claim 1, wherein the receiver comprises a tri-axial sensor that produces an output from which the scalar amplitude of the magnetic field is derived.

5. An apparatus as claimed in claim 4, wherein the processor derives the scalar amplitude of the magnetic field from the output of the tri-axial sensor.

6. An apparatus as claimed in claim 1, wherein the processor filters out specified frequencies from the received signal in order to retain frequencies that are relevant to target geological features.

7. An apparatus as claimed in claim 1, wherein the filtering targets geological features of a specified range of depths.

8. An apparatus as claimed in claim 1, wherein the processor filters out unwanted asynchronous interference relative to the periodic transmitted electromagnetic signal from the received signal.

9. An apparatus as claimed in claim 8, wherein filtering of unwanted asynchronous interference removes frequency components of the received signal which are substantially not at a frequency of the transmitted signal.

10. An apparatus as claimed in claim 1, wherein the filtering of unwanted synchronous signal components is conducted by stacking periodically repeating parts of the received signal.

11. An apparatus as claimed in claim 10, wherein the parts stacked are related to traversal of the sensor over a distance related to a spatial wavelength expected in a received signal from target geological features.

12. An apparatus as claimed in claim 1, wherein the receiver comprises two or more magnetic field sensors operating simultaneously and moving with a substantially fixed separation.

13. An apparatus as claimed in claim 12, wherein the two or more sensors are used so as to calculate a spatial gradient of the scalar magnetic field.

14. A method of analysing geological features comprising:
measuring a scalar amplitude of a magnetic field received from adjacent geological features excited by a periodic transmitted electromagnetic signal and generating a received signal from to the measurement; and
filtering unwanted signal components which are substantially synchronous with the periodic transmitted electromagnetic signal from the received signal, such that target geological features are able to be detected upon further processing of the filtered signal.

15. A computer program comprising instructions for causing a computer processor to:
receive data representing a measured scalar amplitude of a magnetic field received from adjacent geological features excited by a periodic transmitted electromagnetic signal; and
filter unwanted signal components which are substantially synchronous with the periodic transmitted electromagnetic signal from the received data, such that target geological features are able to be detected upon further processing of the filtered data.

16. A computer program product comprising a computer readable medium having computer program logic stored therein, said computer program logic comprising:
program code for receiving data representing a measured scalar amplitude of a magnetic field received from adjacent geological features excited by a periodic transmitted electromagnetic signal; and
program code for filtering unwanted signal components which are substantially synchronous with the periodic transmitted electromagnetic signal from the received data, such that target geological features are able to be detected upon further processing of the filtered data.

17. An apparatus as claimed in claim 1, wherein the processor is configured to filter the unwanted signal components based on timing information related to the periodic transmitted electromagnetic signal.

18. An apparatus as claimed in claim 17, wherein the timing information includes one of:
timing information derived from a timing mechanism synchronized with a transmitter of the periodic electromagnetic signal;
timing information provided by a transmitter of the periodic electromagnetic signal; and
timing information derived from the received data.

19. An apparatus as claimed in claim 1, further comprising:
a transmitter including an antenna for transmitting the periodic electromagnetic signal.

20. An apparatus as claimed in claim 19, wherein the periodic electromagnetic signal is one of:
a periodic alternating polarity square waveform with approximately 50% duty cycle or mark/space ratio;
a periodic alternating polarity square waveform with approximately 100% duty cycle or mark/space ratio;
a sinusoid of a given frequency; and
a superposition or time-sliced combination of waveforms.
